(19) United States
(12) Patent Application Publication
(10) Pub. No.: US 2024/0192370 A1
(43) Pub. Date: Jun. 13, 2024

(54) DISTANCE MEASURING DEVICE AND DISTANCE MEASURING SYSTEM

(71) Applicant: SONY SEMICONDUCTOR SOLUTIONS CORPORATION, KANAGAWA (JP)

(72) Inventors: TOMONORI MASUNO, KANAGAWA (JP); TOMOO MITSUNAGA, KANAGAWA (JP)

(21) Appl. No.: 18/553,737

(22) PCT Filed: Feb. 22, 2022
(86) PCT No.: PCT/JP2022/007176

§ 371 Date: Oct. 3, 2023

(30) Foreign Application Priority Data
Apr. 19, 2021 (JP) 2021-070704

(51) Int. Cl. G01S 17/87; G01S 7/4913; G01S 17/36; G01S 17/48; G01S 17/894

(52) U.S. Cl. CPC G01S 17/87; G01S 7/4913; G01S 17/36; G01S 17/48; G01S 17/894

(57) ABSTRACT

An error in distance measurement is reduced. The distance measuring sensor generates multiple images by receiving light in light reception periods that are synchronized with pulse train pattern light, which repeats a light emission period and a non-light emission period of two types of luminance of a bright portion and a dark portion, and have different phases from each other. A bright region detecting unit detects a bright region which is a region generated by receiving reflected light corresponding to the bright portion of the pattern light in each of the multiple images. A first distance measuring unit detects a phase difference between the emitted pattern light and the reflected light on the basis of the bright regions detected in the multiple images and calculates a first distance measurement value that is a distance to the object on the basis of the detected phase difference. A bright region selecting unit selects among the bright regions, detected in the multiple images, on the basis of image signals constituting the images. A second distance measuring unit calculates a second distance measurement value that is a distance to the object by triangulation using a position of the selected bright region in the image. A fusion unit generates a fused distance measurement value by fusing the first distance measurement value and the second distance measurement value.

### FIELD

The present disclosure relates to a distance measuring device and a distance measuring system.

### BACKGROUND

A distance measuring device based on the time of flight (ToF) method is used which measures a distance to an object by irradiating the object with light and measuring the time for the light to reciprocate between the object and the distance measuring device. For example, a distance measuring device including a light emitting unit that emits amplitude-modulated light to an object and a light receiving element that receives reflected light obtained by reflecting emitted light by the object is used. As the light receiving element, an imaging element that generates an image signal on the basis of the reflected light is used. The imaging element generates multiple image signals by performing synchronous detection synchronized with the amplitude-modulated emitted light on the received reflected light. The phase difference between the emitted light and the reflected light can be detected by mutual calculation of the multiple generated image signals, and the distance to the object can be calculated based on the detected phase difference. Such a distance measuring method is referred to as the indirect ToF method as opposed to the direct ToF method in which a timer is used to directly measure the time for the above light to reciprocate.

In the indirect ToF method, for example, four images are generated by taking images in phases of 0 degrees, 90 degrees, 180 degrees, and 270 degrees with respect to the emitted light. For the four images, differences are calculated between components of the same phase as the emitted light (images of 0 degrees and 180 degrees phases) and components orthogonal to the emitted light (phases of 90 degrees and 270 degrees). When the differences are denoted by I and Q, respectively, a phase difference θ can be calculated by arctan (Q/I). Such an indirect ToF method is referred to as a four-phase method. In this four-phase method, noise and the like can be removed at the time of calculating the above-described differences.

However, since generation of four images is required in the four-phase method, there is a problem that an error occurs when an object moves. Thus, there has been proposed a distance measuring module that determines whether or not an object has moved and performs distance measurement during a period in which it is determined that the object has not moved (See, for example, Patent Literature 1.).

### CITATION LIST

### Patent Literature

Patent Literature 1: JP 2017-150893 A

### SUMMARY

### Technical Problem

However, the above-described conventional technique has a problem in that it is difficult to reduce an error in distance measurement of a moving object.

Thus, the present disclosure proposes a distance measuring device and a distance measuring system that reduce an error in distance measurement of a moving object.

### Solution to Problem

An information processing system according to the present disclosure includes: A distance measuring device comprising: a distance measuring sensor configured to generate a plurality of images by receiving reflected light, which is obtained by reflecting pulse train pattern light that repeats a light emission period and a non-light emission period of two types of luminance of a bright portion and a dark portion by an object, in light reception periods that are each synchronized with the light emission period and have different phases from each other; a bright region detecting unit configured to detect a bright region which is a region generated by receiving the reflected light corresponding to the bright portion of the pattern light in each of the plurality of images; a first distance measuring unit configured to detect a phase difference between the emitted pattern light and the reflected light on the basis of the bright regions detected in the plurality of images and calculate a first distance measurement value that is a distance to the object on the basis of the detected phase difference; a bright region selecting unit configured to select among the bright regions, detected in the plurality of images, on the basis of image signals constituting the images; a second distance measuring unit configured to calculate a second distance measurement value that is a distance to the object by triangulation using a position of the selected bright region in the image; and a fusion unit configured to generate a fused distance measurement value by fusing the calculated first distance measurement value and the calculated second distance measurement value.

### BRIEF DESCRIPTION OF DRAWINGS

FIG. 1 is a diagram illustrating a configuration example of a distance measuring system according to an embodiment of the present disclosure.

FIG. 2A is a diagram illustrating an example of a light emission pattern according to the embodiment of the present disclosure.

FIG. 2B is a diagram illustrating an example of reflected light according to the embodiment of the present disclosure.

FIG. 3 is a diagram illustrating a configuration example of a light source device and a distance measuring device according to the embodiment of the present disclosure.

FIG. 4 is a diagram illustrating a configuration example of a distance measuring sensor according to the embodiment of the present disclosure.

FIG. 5 is a diagram illustrating a configuration example of a pixel according to the embodiment of the present disclosure.

FIG. 6 is a diagram illustrating an example of image generation in the indirect ToF method according to the embodiment of the present disclosure.

FIG. 7 is a diagram illustrating an example of generation of an image signal according to the embodiment of the present disclosure.

FIG. 8 is a diagram illustrating an example of triangulation according to the embodiment of the present disclosure.

FIG. 9 is a diagram illustrating an example of selection of a bright region according to the embodiment of the present disclosure.

FIG. 10 is a diagram illustrating an example of distance measurement processing according to the embodiment of the present disclosure.

FIG. 11 is a diagram illustrating an example of bright region selection processing according to the embodiment of the present disclosure.

FIG. 12 is a diagram illustrating an example of luminance difference detection processing according to the embodiment of the present disclosure.

FIG. 13 is a diagram illustrating an example of second distance measurement value calculation processing according to the embodiment of the present disclosure.

FIG. 14 is a diagram illustrating an example of fusion processing according to the embodiment of the present disclosure.

FIG. 15 is a diagram illustrating an example of bright region selection processing according to a second embodiment of the present disclosure.

FIG. 16 is a diagram illustrating an example of fusion processing according to a third embodiment of the present disclosure.

### DESCRIPTION OF EMBODIMENTS

Hereinafter, embodiments of the present disclosure will be described in detail with reference to the drawings. The description will be given in the following order. Note that, in the following embodiments, the same parts are denoted by the same reference signs to omit redundant description.
1. First Embodiment
2. Second Embodiment
3. Third Embodiment

### 1. First Embodiment

### [Configuration of Distance Measuring System]

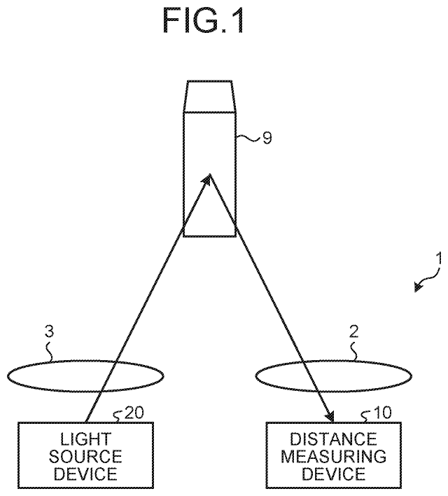

FIG. 1 is a diagram illustrating a configuration example of a distance measuring system according to an embodiment of the present disclosure. This diagram is a diagram illustrating a configuration example of a distance measuring system 1. The distance measuring system 1 is a system that measures a distance to an object. The distance measuring system 1 in this diagram illustrates an example of measuring a distance to a rectangular parallelepiped object 9. The distance measuring system 1 includes: a light source device 20; a distance measuring device 10; and lenses 2 and 3. Note that, arrows in this diagram represent light emitted from the light source device 20, reflected by the object 9, and incident on the distance measuring device 10.

The light source device 20 is configured to irradiate a distance measurement target with light. The light source device 20 emits pattern light having two types of bright and dark luminance. In addition, this pattern light emits pulse train pattern light that repeats a light emission period and a non-light emission period in a predetermined cycle. The configuration of the light source device 20 will be described in detail later.

The distance measuring device 10 is configured to measure a distance to an object. The distance measuring device 10 receives reflected light obtained in such a way that pattern light emitted from the light source device 20 is reflected by a target object (object 9). By this reception of light, the time from the emission of the light emission pattern of the light source device 20 to the arrival of the reflected light is measured, and the distance to the object is measured. The configuration of the distance measuring device 10 will be described in detail later.

The lens 2 is a lens that condenses light incident on the distance measuring device 10. The lens 3 is a lens that condenses light emitted from the light source device 20.

### [Light Emission Pattern]

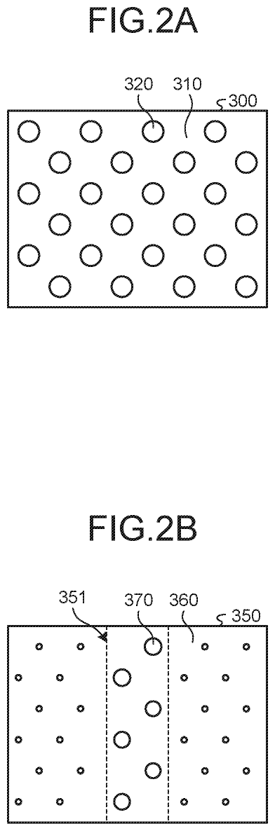

FIG. 2A is a diagram illustrating an example of pattern light according to the embodiment of the present disclosure. This diagram is a diagram illustrating an example of pattern light emitted by the light source device 20. Pattern light 300 in this diagram includes a bright portion 320 and a dark portion 310. This diagram illustrates an example of the pattern light 300 constituted of a dot pattern in which the bright portion 320 in the form of multiple dots is arranged in the dark portion 310 as the background.

FIG. 2B is a diagram illustrating an example of reflected light according to the embodiment of the present disclosure. This diagram is a diagram illustrating reflected light 350 in which the pattern light 300 is reflected by the object 9 in FIG. 1 and the like. The reflected light 350 corresponds to reflected light incident on the distance measuring device 10. The reflected light 350 includes a bright region 370 and a dark region 360 corresponding to the bright portion 320 and the dark portion 310 of the pattern light 300, respectively. The multiple bright regions 370 in this diagram are formed in a shape corresponding to the distance to the object. Dotted lines in this diagram represent a region of the reflected light 351 reflected by the object 9. The bright region 370 of the reflected light 351 reflected by the object 9 at a relatively short distance is formed as a dot larger than the other bright regions 370. Further, as will be described later, the position of the bright region 370 changes according to the distance to the object.

### [Configuration of Light Source Device and Distance Measuring Device]

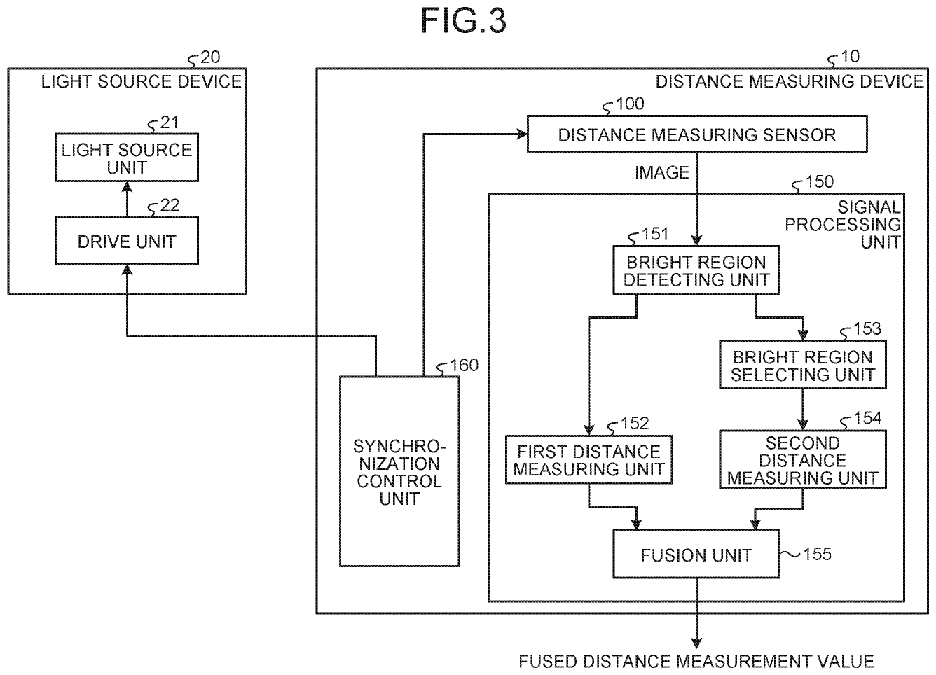

FIG. 3 is a diagram illustrating a configuration example of the light source device and the distance measuring device according to the embodiment of the present disclosure. This diagram is a block diagram illustrating a configuration example of the light source device 20 and the distance measuring device 10 constituting the distance measuring system 1.

The light source device 20 includes a light source unit 21 and a drive unit 22.

The light source unit 21 is configured to generate pattern light to irradiate the object 9. The light source unit 21 can be constituted of a light source that emits laser light. For example, a configuration in which the light source is arranged in a portion corresponding to the bright portion 320 in the pattern light 300 and no light source is arranged in a portion corresponding to the dark portion 310 can be employed.

The drive unit 22 is configured to drive the light source unit 21. The drive unit 22 drives the light source unit to emit pulse train pattern light that repeats a light emission period and a non-light emission period in a predetermined cycle. The timing of emission of the pulse train pattern light in the predetermined cycle is controlled by a synchronization control unit 160 of the distance measuring device 10 to be described later.

The distance measuring device 10 includes a distance measuring sensor 100, a signal processing unit 150, and the synchronization control unit 160.

The distance measuring sensor 100 is configured to receive the reflected light 350 and generate an image. The distance measuring sensor 100 can be constituted of, for example, a complementary metal oxide semiconductor (CMOS) type imaging element. The distance measuring sensor 100 receives light in light reception periods that are each synchronized with the light emission period of the pattern light 300 and have different phases from each other, and generates multiple images corresponding to the respective phases. As will be described later, the imaging element constituting the distance measuring sensor 100 includes multiple pixels that generate an image signal according to incident light. An image is constituted by an image signal for one screen generated by the multiple pixels. The distance measuring sensor 100 outputs the generated image to the signal processing unit 150.

The signal processing unit 150 is configured to perform distance measurement processing of measuring the distance to the object on the basis of the image output from the distance measuring sensor 100. The signal processing unit 150 includes: a bright region detecting unit 151; a first distance measuring unit 152; a bright region selecting unit 153; a second distance measuring unit 154; and a fusion unit 155.

The bright region detecting unit 151 is configured to detect the bright region 370 of the reflected light 350. The bright region detecting unit 151 detects the position of the bright region 370 for each of the multiple images output from the distance measuring sensor 100. The bright region detecting unit 151 outputs the detected bright region 370 to the first distance measuring unit 152 and the bright region selecting unit 153.

The first distance measuring unit 152 is configured to calculate the distance to the object 9 on the basis of the phase difference between the pattern light 300 and the reflected light 350. The first distance measuring unit 152 detects the phase difference between the pattern light 300 and the reflected light 350 on the basis of the bright region 370 of each of the multiple images output from the bright region detecting unit 151, and performs distance measurement by the indirect ToF method on the basis of the detected phase difference. The distance calculated by the first distance measuring unit 152 is referred to as a first distance measurement value. The first distance measuring unit 152 outputs the calculated first distance measurement value to the fusion unit 155. Details of the distance measurement in the first distance measuring unit 152 will be described later.

The bright region selecting unit 153 is configured to select the bright region 370 output from the bright region detecting unit 151. The bright region selecting unit 153 selects the bright region 370 on the basis of the image signal constituting the image. For example, the bright region selecting unit 153 can select, among the bright regions 370 included in the respective multiple images, the bright region 370 having the maximum luminance difference from the dark region 360. The bright region selecting unit 153 outputs the selected bright region 370 to the second distance measuring unit 154. Details of selection of the bright region 370 in the bright region selecting unit 153 will be described later.

The second distance measuring unit 154 is configured to calculate the distance to the object 9 by triangulation using the position of the bright region 370 in the image. The second distance measuring unit 154 performs distance measurement based on the principle of triangulation on the position in the image of the bright region 370 selected by the bright region selecting unit 153 and the position of the bright portion of the pattern light 300 corresponding to this bright region 370. The distance calculated by the second distance measuring unit 154 is referred to as a second distance measurement value. The second distance measuring unit 154 outputs the calculated second distance measurement value to the fusion unit 155. Details of the distance measurement in the second distance measuring unit 154 will be described later.

The fusion unit 155 is configured to generate a fused distance measurement value by fusing the first distance measurement value calculated by the first distance measuring unit 152 and the second distance measurement value calculated by the second distance measuring unit 154 with each other. The generated fused distance measurement value is output as a detected distance measurement value of the distance measuring device 10. Details of fusion of the first distance measurement value and the second distance measurement value in the fusion unit 155 will be described later.

The synchronization control unit 160 is configured to synchronize the light emission period and the non-light emission period of the pattern light 300 in the light source device 20 with the timing of generating the image signal in the distance measuring sensor 100. The synchronization control unit 160 outputs a control signal to the drive unit 22 and the distance measuring sensor 100 of the light source device 20, and synchronizes the drive timing of the light source unit 21 by the drive unit 22 with synchronous detection to be described later at the time of generating an image signal in a pixel (a pixel 200 to be described later) of the distance measuring sensor 100.

### [Configuration of Imaging Element]

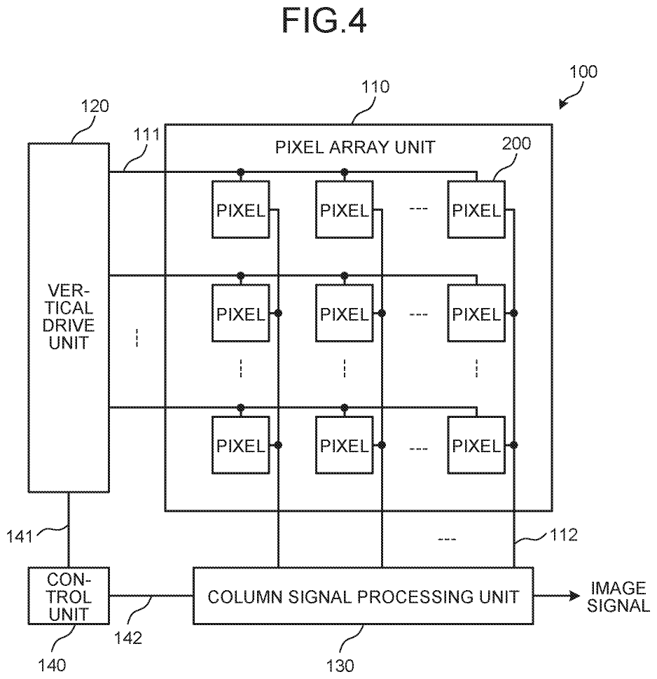

FIG. 4 is a diagram illustrating a configuration example of the distance measuring sensor according to the embodiment of the present disclosure. This diagram is a block diagram illustrating a configuration example of the distance measuring sensor 100. The distance measuring sensor 100 is a semiconductor element that generates an image of a subject. The distance measuring sensor 100 includes: a pixel array unit 110; a vertical drive unit 120; a column signal processing unit 130; and a control unit 140.

The pixel array unit 110 is constituted by arranging multiple pixels 200. The pixel array unit 110 in this diagram illustrates an example in which the multiple pixels 200 are arranged in the shape of a two-dimensional matrix. Here, each pixel 200 includes a photoelectric conversion unit that performs photoelectric conversion of incident light and generates an image signal of a subject on the basis of the emitted incident light. For example, a photodiode can be used as the photoelectric conversion unit. Signal lines 11 and 12 are wired to each pixel 200. The pixel 200 is controlled by a control signal transmitted by the signal line 11 to generate an image signal, and outputs the generated image signal via the signal line 12. Note that, the signal line 11 is arranged for each row in the shape of a two-dimensional matrix, and is wired to all of the multiple pixels 200, arranged in a row, in common. The signal line 12 is arranged for each row in the shape of a two-dimensional matrix, and is wired to all of the multiple pixels 200, arranged in a row, in common.

The vertical drive unit 120 is configured to generate a control signal of the pixels 200 described above. The vertical drive unit 120 in this diagram generates a control signal for each row in the form of a two-dimensional matrix of the pixel array unit 110 and sequentially outputs the control signal via the signal line 11.

The column signal processing unit 130 is configured to process the image signal generated by the pixels 200. The column signal processing unit 130 in this diagram simultaneously processes the image signals that are transmitted from the multiple pixels 200, arranged in one row of the pixel array unit 110, via the signal line 12. As this processing, for example, analog-digital conversion of converting an analog image signal generated by the pixels 200 into a digital image signal and correlated double sampling (CDS) of removing an offset error of an image signal can be performed. The processed image signal is output to a circuit or the like outside the distance measuring sensor 100.

The control unit 140 is configured to control the vertical drive unit 120 and the column signal processing unit 130. The control unit 140 in this diagram outputs control signals via signal lines 141 and 142, respectively, to control the vertical drive unit 120 and the column signal processing unit 130.

### [Configuration of Pixel]

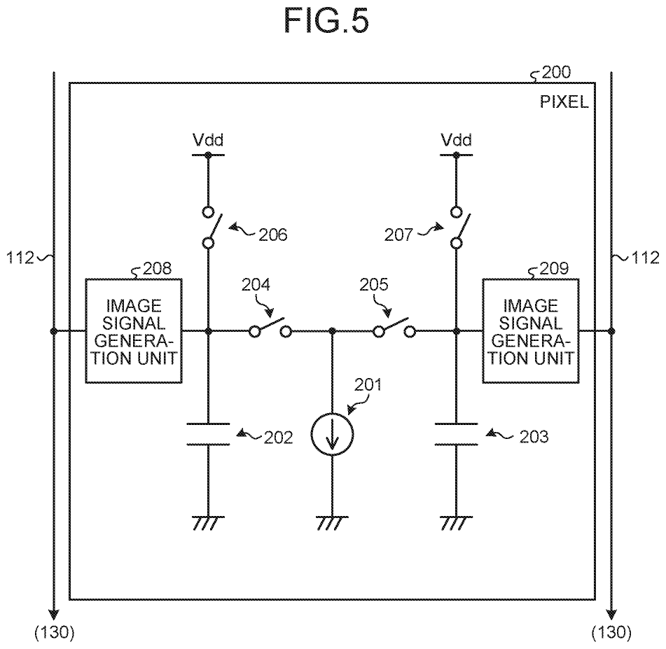

FIG. 5 is a diagram illustrating a configuration example of the pixel according to the embodiment of the present disclosure. This diagram is a circuit diagram illustrating a configuration example of each pixel 200 arranged in the distance measuring sensor 100. The pixel 200 in this diagram includes: a photoelectric conversion unit 201; charge holding units 202 and 203; transfer units 204 and 205; reset units 206 and 207; and image signal generation units 208 and 209. The transfer units 204 and 205 and the reset units 206 and 207 can be constituted of MOS transistors. Further, a power supply line Vdd is wired to the pixel 200 in this diagram. The power supply line Vdd is a wiring that supplies power to the pixel 200.

The photoelectric conversion unit 201 is configured to perform photoelectric conversion of incident light. The photoelectric conversion unit 201 can be constituted of a photodiode. The photodiode supplies electric charge, generated by photoelectric conversion, to an external circuit. Thus, as illustrated in this diagram, the photoelectric conversion unit 201 can be represented by a constant current circuit. The photoelectric conversion unit 201 in this diagram has one end which is grounded, and the other end from which to supply a sink current corresponding to incident light.

The charge holding units 202 and 203 are configured to hold the electric charge generated by the photoelectric conversion unit 201. Each of the charge holding units 202 and 203 can be constituted by a floating diffusion (FD) that holds electric charge in a diffusion region formed in a semiconductor substrate.

The transfer units 204 and 205 are configured to transfer the charges, generated by the photoelectric conversion unit 201, to the charge holding units 202 and 203, respectively. The transfer unit 204 transfers the charge of the photoelectric conversion unit 201 to the charge holding unit 202 by electrically connecting the photoelectric conversion unit 201 and the charge holding unit 202 to each other. Meanwhile, the transfer unit 205 transfers the charge of the photoelectric conversion unit 201 to the charge holding unit 203 by electrically connecting the photoelectric conversion unit 201 and the charge holding unit 203 to each other.

The reset units 206 and 207 are configured to reset the charge holding units 202 and 303. The reset unit 206 performs reset by electrically connecting the charge holding unit 202 and the power supply line Vdd to each other and discharging the charge of the charge holding unit 202 to the power supply line Vdd. Likewise, the reset unit 207 resets the charge holding unit 203 by electrically connecting the charge holding unit 203 and the power supply line Vdd to each other.

The image signal generation units 208 and 209 are configured to generate image signals on the basis of the charges held in the charge holding units 202 and 203. The image signal generation unit 208 generates an image signal on the basis of the charge held in the charge holding unit 202, and outputs the image signal to the signal line 112. The image signal generation unit 208 generates an image signal on the basis of the charge held in the charge holding unit 202, and outputs the image signal to the signal line 112. The image signal generation unit 209 generates an image signal on the basis of the charge held in the charge holding unit 203, and outputs the image signal to the signal line 112.

Note that, control signals of the transfer units 204 and 205, the reset units 206 and 207, and the image signal generation units 208 and 209 are transmitted via the signal line 111 (not illustrated).

Generation of the image signal in the pixel 200 in this diagram can be performed as follows. First, the reset units 206 and 207 are electrically connected to reset the charge holding units 202 and 203. After completion of the reset, the transfer units 204 and 205 are electrically connected to transfer the charge, generated by the photoelectric conversion unit 201, to the charge holding unit 202 and cause the charge holding unit 202 to hold the charge. At this time, the transfer units 204 and 205 alternately become conductive and distribute the charges, generated by the photoelectric conversion unit 201, to the charge holding units 202 and 203. This charge distribution is performed multiple times to cause the charge holding units 202 and 203 to accumulate the charges generated by the photoelectric conversion unit 201. A period during which this charge is accumulated is referred to as an accumulation period.

After a predetermined accumulation period elapses, the transfer units 204 and 205 become nonconductive. Thereafter, the image signal generation units 208 and 209 generate and output image signals on the basis of the charges accumulated in the charge holding units 202 and 203.

In the accumulation period described above, the charge of the photoelectric conversion unit 201 is distributed by the transfer units 204 and 205 and accumulated, and image signals are generated on the basis of the accumulated charges. The distribution of the transfer units 204 and 205 is performed in synchronization with the cycle of the light emission period and the non-light emission period of the pattern light 300 of the light source device 20 described in FIG. 3. This makes it possible to perform synchronous detection of the reflected light incident on the distance measuring sensor 100. Further, by generating multiple image signals by performing the synchronous detection with different phases, it is possible to execute the indirect ToF method of detecting the time taken from the light source device 20 to the distance measuring sensor 100 via the object 9 as a phase difference with respect to the light emission and non-light emission cycles of the light source device 20. Note that, the image signal corresponding to the charge holding unit 202 and the image signal corresponding to the charge holding unit 203 are referred to as an image signal of a tap A and an image signal of a tap B, respectively. [Image Generation in Indirect ToF Method]

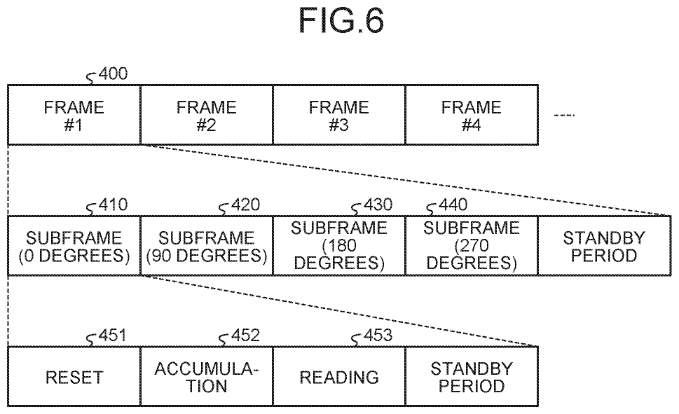

FIG. 6 is a diagram illustrating an example of image generation in the indirect ToF method according to the embodiment of the present disclosure. This diagram is a diagram illustrating generation of an image used for the indirect ToF method in the pixel 200. Frames 400 in this diagram represent a period for generating an image in the indirect ToF method. As illustrated in this diagram, the multiple frames 400 are continuously executed, and distance measurement by the indirect ToF method is continuously executed.

Each frame 400 includes subframes 410, 420, 430, and 440. In the subframes 410, 420, 430, and 440, the transfer units 204 and 205 described above perform distribution in different phases. The subframes 410, 420, 430, and 440 are distributed by the transfer units 204 and 205 in phases of 0 degrees, 90 degrees, 180 degrees, and 270 degrees, respectively, to generate images. Note that, the frame 400 further includes a standby period. The standby period is a period corresponding to a so-called dead time.

The subframe 410 and the like each include periods of reset 451, accumulation 452, and reading 453. The reset 451 is a reset period by the above-described reset units 206 and 207. The accumulation 452 is a period corresponding to the accumulation period described above. The reading 453 is a period in which the image signals generated by the image signal generation units 208 and 209 are read out. Note that, the subframe 410 and the like further include a standby period.

### [Generation of Image Signal in Indirect ToF Method]

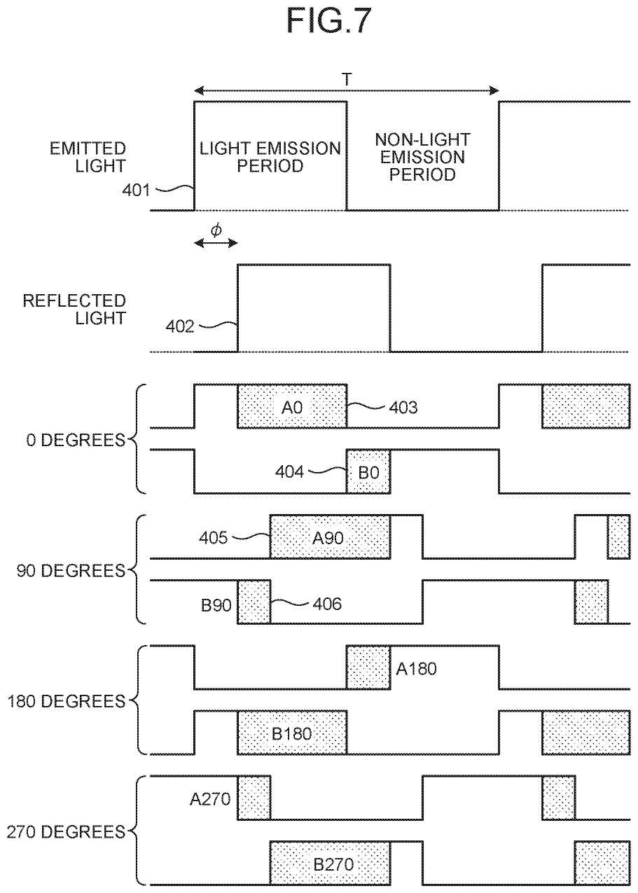

FIG. 7 is a diagram illustrating an example of generation of an image signal according to the embodiment of the present disclosure. This diagram is a timing chart illustrating an example of generation of an image signal in the indirect ToF method in the pixel 200. In this diagram, the distance measuring unit 330 performs control to distribute the reflected light 4 in four different phases and generate an image signal.

As the emitted light in this diagram, the emitted light of a cycle T including the light emission period and the non-light emission period of substantially equal periods is employed. The light emission period of the emitted light in this diagram is a rectangular wave with constant luminance. Hereinafter, this rectangular wave is referred to as pulse light 401. Reflected light including pulse light 402 with constant luminance is incident on the pixel 200 according to the emitted light. The reflected light is synchronized with the emitted light, and charges are distributed in four delay phases of 0 degrees, 90 degrees, 180 degrees, and 270 degrees to generate image signals A and B.

“0 degrees”, “90 degrees”, “180 degrees”, and “270 degrees” in this diagram respectively represent waveforms in a case where charges are distributed in the four delay phases of 0 degrees, 90 degrees, 180 degrees, and 270 degrees. An upper waveform of each of these waveforms represents the tap A, and a lower waveform represents the tap B. In addition, solid line waveforms at “0 degrees”, “90 degrees”, “180 degrees”, and “270 degrees” in this diagram represent guide signals representing the charge distribution periods of the respective taps in the respective delay phases. The charge is distributed to its own tap in a period in which the guide signal has a value “1”. Further, hatched regions at “0 degrees”, “90 degrees”, “180 degrees”, and “270 degrees” in this diagram represent accumulation of charges in the charge holding units (charge holding units 202 and 203) of the respective taps.

A case where the phase delay is 0 degrees in this diagram will be described as an example. In the tap A (upper side), a charge is accumulated in the charge holding unit 202 in a period in which the pulse light 402 of the reflected light and the portion having the value “1” of the guide signal overlap with each other. “A0” in this diagram represents an accumulated charge A0 in the charge holding unit 202 on the tap A side. Meanwhile, in the tap B (lower side), a charge is accumulated in the charge holding unit 203 in a period in which the pulse light 402 of the reflected light and the portion having the value “1” of the guide signal overlap with each other. “B0” in this diagram represents an accumulated charge B0 in the charge holding unit 203 on the tap B side. The accumulation of charges in the taps A and B is iterated in the accumulation period.

Likewise, in the delay phases of 90 degrees, 180 degrees, and 270 degrees, accumulation of charges in the taps A and B is iterated in the accumulation period. Then, accumulated charges A90 and B90, accumulated charges A180 and B180, and accumulated charges A270 and B270 are generated in the delay phases of 90 degrees, 180 degrees, and 270 degrees.

Next, based on the accumulated charges A0 and B0, an image signal A0 of the tap A and an image signal B0 of the tap B at 0 degrees are generated. In addition, an image signal A90 of the tap A and an image signal B90 of the tap B at 90 degrees are generated. Further, an image signal A180 of the tap A and an image signal B180 of the tap B at 180 degrees are generated. Furthermore, an image signal A270 of the tap A and an image signal B270 of the tap B at 270 degrees are generated. A phase difference ϕ between the emitted light and the reflected light is calculated from these eight signals.

The following calculation is performed using the above-described tap A0 and the like to calculate Signal0 to Signal3.

Signal0=Tap A0−Tap B0

Signal 1=tap A90−tap B90

Signal 2=tap A180−tap B180

Signal 3=tap A270−tap B270

Next, the following calculation is performed using Signal0 to Signal3 to calculate I and Q.

I=(Signal0−Signal1)/2

Q=(Signal2−Signal3)/2

Here, I is a signal corresponding to a component of the same phase as the emitted light of the reflected light. Further, Q is a signal corresponding to a component in a direction orthogonal to the emitted light of the reflected light. A distance d to the object 9 can be calculated by the following formula based on I and Q and the cycle T of the emitted light.

d=c×T×arctan (Q/I)/4π Formula (1)

Here, c represents the speed of light.

In this manner, distance measurement by the indirect ToF method can be performed. In this indirect ToF method, it is necessary to generate four images. When the object 9 moves during the period in which the four images are generated, an error occurs in the calculated distance. Therefore, distance measurement by triangulation described below is further performed. In the distance measurement by triangulation, four images of the tap A and four images of the tap B generated by the indirect ToF method can be used.

### [Distance Measurement by Triangulation]

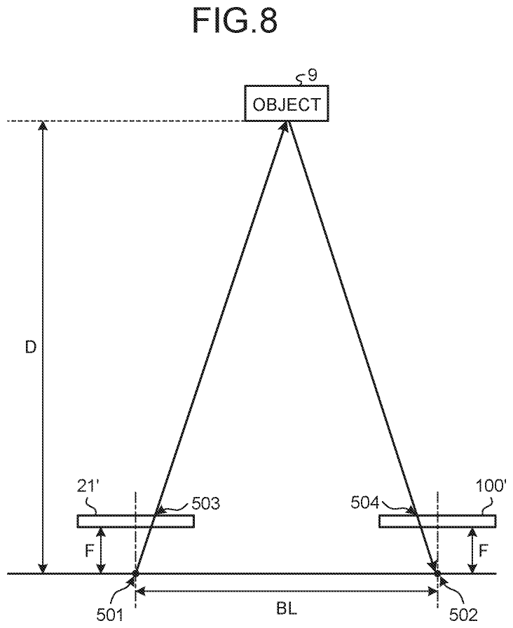

FIG. 8 is a diagram illustrating an example of triangulation according to the embodiment of the present disclosure. This diagram is a diagram illustrating the principle of triangulation. In this diagram, the light source device 20 is disposed at a position 501, and the distance measuring sensor 100 is disposed at a position 502. A virtual light source device 20′ is arranged at a position away from the position 501 by a focal distance F of the lens 3, and a virtual distance measuring sensor 100′ is arranged at a position away from the position 502 by the focal distance F of the lens 2. “BL” represents a distance between the light source device 20 and the distance measuring sensor 100, and “D” represents a distance to the object 9. Further, arrows in this diagram indicate trajectories of the pattern light 300 emitted from the light source device 20 and the reflected light reflected by the object 9.

In this diagram, the light of the bright portion 320 at the position of a point 503 of the light source device 20′ is reflected by the object 9 and detected as the bright region 370 at a point 504 of the distance measuring sensor 100′. In this case, since the distance BL between the light source device 20 and the distance measuring sensor 100 is known, the distance D can be calculated using the principle of triangulation by detecting the position of the point 503 in the pattern light 300 and the position of the point 504 in the image generated by the distance measuring sensor 100.

### [Selection of Bright Region]

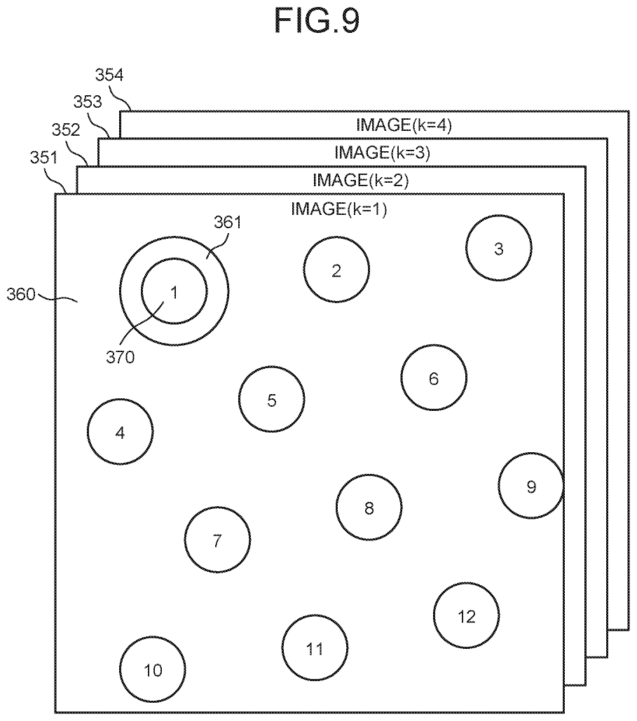

FIG. 9 is a diagram illustrating an example of selection of the bright region according to the embodiment of the present disclosure. This diagram is a diagram illustrating selection of the bright region 370 in the bright region selecting unit 153. Images 351 to 354 in this diagram represent four images of the tap A or the tap B generated by the distance measuring sensor 100. The bright region 370 is arranged in each of these images. The bright region detecting unit 151 detects the bright region 370 from these images. The detection of the bright region 370 by the bright region detecting unit 151 can be performed by, for example, a blob detection method.

The bright region detecting unit 151 identifies the detected bright region 370 by an image number and a position number. Hereinafter, the detected bright region 370 is represented by b(k, n). Here, k is a number for identifying the four images, and is a value of 1 to 4 corresponding to the images 351 to 354. n is a number representing a position in the image 351 or the like, and is a number assigned to each bright region 370. For example, n can be assigned with numbers such as 1, 2, and 3 in order from the upper left of the image 351 and the like. b (k, n) can be constituted by coordinates of pixels included in the range of the bright region 370. Note that, in the images 351 to 354, it is assumed that the bright regions 370 are arranged at overlapping positions. This is based on the assumption that the movement of the object 9 is sufficiently shorter than the period of distance measurement by the indirect ToF method.

The bright region selecting unit 153 can perform selection on the basis of the luminance difference between the bright region 370 and the dark region 360. For example, the bright region selecting unit 153 can select the bright region 370 having the largest luminance difference among the bright regions 370 having the same position number in the images 351 to 354.

The bright region selecting unit 153 can detect, for example, the luminance difference between a peripheral region 361, which is a region around the bright region 370, and the bright region 370. The bright region selecting unit 153 can also detect the difference between the average luminance of the dark region 360 and the luminance of the bright region 370 in the image 351 and the like.

The bright region selecting unit 153 can also perform selection on the basis of the noise of the bright region 370. For example, the bright region selecting unit 153 can select the bright region 370 in which the noise component of the image signal of the bright region 370 is smaller than a predetermined threshold.

The second distance measuring unit 154 performs distance measurement by triangulation on the bright region 370 selected by the bright region selecting unit 153. At this time, the second distance measuring unit 154 selects the bright portion 320 of the pattern light 300 corresponding to the selected bright region 370. In addition, the second distance measuring unit 154 calculates a center position of the selected bright portion 320 and a center position of the selected bright region 370, and performs triangulation. Note that, as the center position of the bright region 370, for example, a position where the luminance in the bright region 370 is maximized can be employed. The position where the luminance is maximized in the bright region 370 can be detected by, for example, parabola fitting or the like. As the center position of the bright portion 320, a predetermined value can be used.

### [Fusion Processing]

As described above, the fusion unit 155 fuses the first distance measurement value and the second distance measurement value. This fusion can be performed by weighted addition of the first distance measurement value and the second distance measurement value. Further, as the weight, for example, a weight corresponding to the difference between the first distance measurement value and the second distance measurement value can be employed. For example, in a case where the difference between the first distance measurement value and the second distance measurement value is small, substantially the same weight can be set to the first distance measurement value and the second distance measurement value. Then, as the difference between the first distance measurement value and the second distance measurement value increases, it is possible to set the weight of the second distance measurement value larger while setting the weight of the first distance measurement value smaller. Alternatively, for example, it is also possible to set, with the second distance measurement value set as a true value, a weight based on a normal distribution curve according to the difference between the second distance measurement value and the first distance measurement value.

### [Distance Measurement Processing]

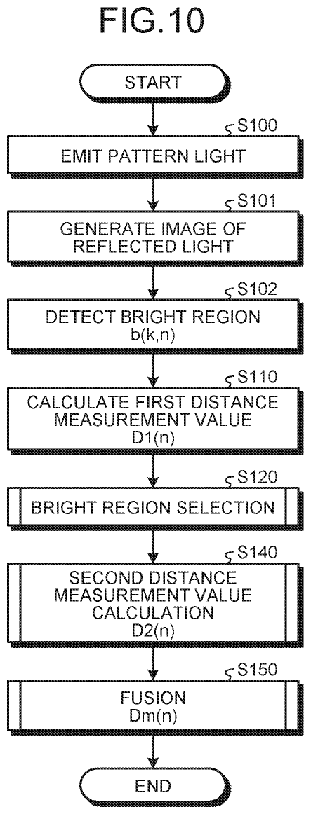

FIG. 10 is a diagram illustrating an example of distance measurement processing according to the embodiment of the present disclosure. This diagram is a diagram illustrating an example of the distance measurement processing in the distance measuring system 1. First, the light source device 20 emits pattern light (Step S100). Next, the distance measuring sensor 100 generates an image of the reflected light (Step S101). Next, the bright region detecting unit 151 detects the bright region (Step S102). At this time, b(k, n) is generated by the bright region detecting unit 151. Next, the first distance measuring unit 152 calculates the first distance measurement value by the indirect ToF method (Step S110). At this time, the first distance measuring unit 152 calculates the first distance measurement value for each bright region 370. The first distance measuring unit 152 generates the first distance measurement value D1(n) identified by the position number.

Next, the bright region selecting unit 153 performs bright region selection processing (Step S120). Next, the second distance measuring unit 154 calculates the second distance measurement value (Step S140). The second distance measuring unit 154 generates the second distance measurement value D2(n) identified by the position number. Next, the fusion unit 155 performs fusion processing (Step S150) on the first distance measurement value D1(n) and the second distance measurement value D2(n) to generate a fused distance measurement value.

### [Bright Region Selection Processing]

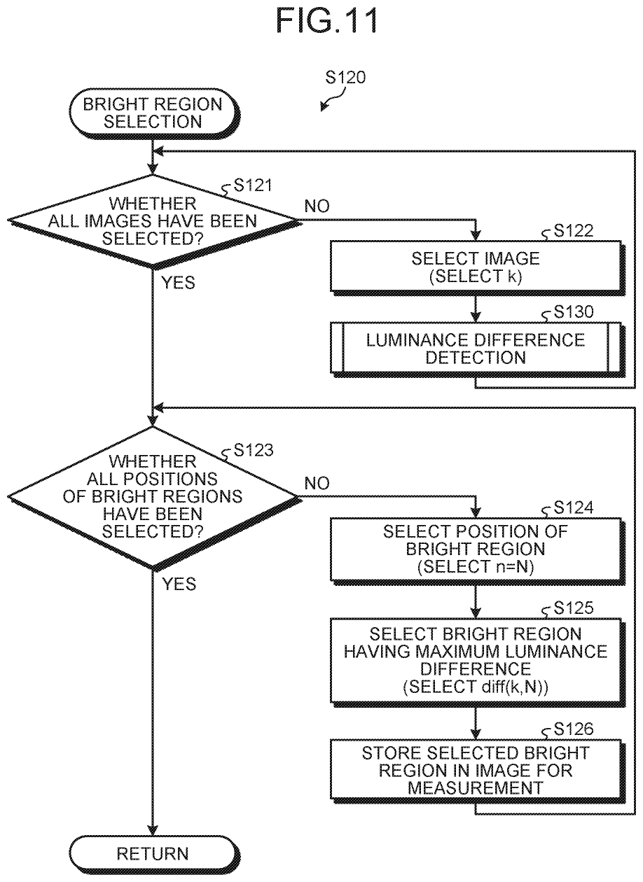

FIG. 11 is a diagram illustrating an example of bright region selection processing according to the embodiment of the present disclosure. This diagram is a diagram illustrating an example of the bright region selection processing (Step S120) in FIG. 10. First, the bright region selecting unit 153 detects the luminance difference of the bright region 370 for all images. The bright region selecting unit 153 determines whether or not all the images have been selected (Step S121), and in a case where not all the images have been selected (Step S121, No), selects the unselected image (Step S122). At this time, the bright region selecting unit 153 selects an image number k. Next, the bright region selecting unit 153 performs luminance difference detection processing (Step S130) on the selected image, and returns to the process of Step S121.

On the other hand, in Step S121, in a case where all the images have been selected (Step S121, Yes), the process proceeds to Step S123. In Step S123, the bright region selecting unit 153 determines whether or not all the positions of the bright regions have been selected (Step S123), and in a case where not all the positions of the bright regions have been selected (Step S123, No), selects the position of the unselected bright region (Step S124). At this time, the bright region selecting unit 153 selects N as a position number n. Next, the bright region selecting unit 153 selects the bright region having the maximum luminance difference (Step S125). At this time, the bright region selecting unit 153 selects the bright region 370 having the maximum luminance difference (diff (k, N) to be described later) among the bright regions 370 having the position number N.

Next, the bright region selecting unit 153 stores the selected bright region 370 in an image for measurement (Step S126). Next, the bright region selecting unit 153 returns to the process of Step S123. On the other hand, in Step S123, in a case where all the bright regions have been selected (Step S123, Yes), the bright region selecting unit 153 terminates the bright region selection processing S120.

### [Luminance Difference Detection Processing]

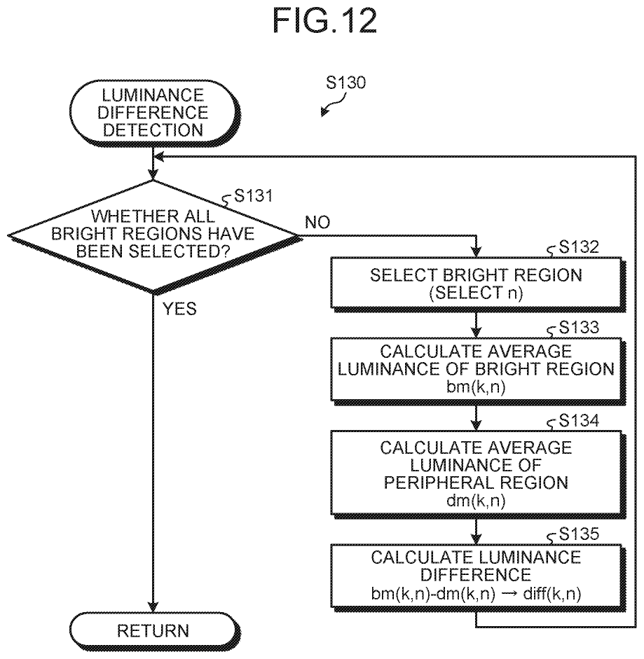

FIG. 12 is a diagram illustrating an example of luminance difference detection processing according to the embodiment of the present disclosure. This diagram is a diagram illustrating an example of the luminance difference detection processing (Step S130) in FIG. 11. First, the bright region selecting unit 153 determines whether or not all the bright regions have been selected (Step S131), and in a case where not all the bright regions have been selected, selects the unselected bright region (Step S132). At this time, the bright region selecting unit 153 selects the position number n of the bright region 370. Next, the bright region selecting unit 153 calculates the average luminance of the selected bright region (Step S133). At this time, the bright region selecting unit 153 calculates the average luminance bm(k, n). Next, the bright region selecting unit 153 calculates the average luminance of the peripheral region described in FIG. 9 (Step S134). At this time, the bright region selecting unit 153 calculates the average luminance dm (k, n) of the peripheral region.

Next, the bright region selecting unit 153 calculates a luminance difference (Step S135). At this time, the bright region selecting unit 153 calculates bm (k, n)−dm (k, n) and outputs its result as diff (k, n). Next, the bright region selecting unit 153 returns to the process of Step S131. On the other hand, in the process of Step S131, in a case where all the bright regions have been selected (Step S131, Yes), the bright region selecting unit 153 completes the luminance difference detection processing S130.

### [Second Distance Measurement Value Calculation Processing]

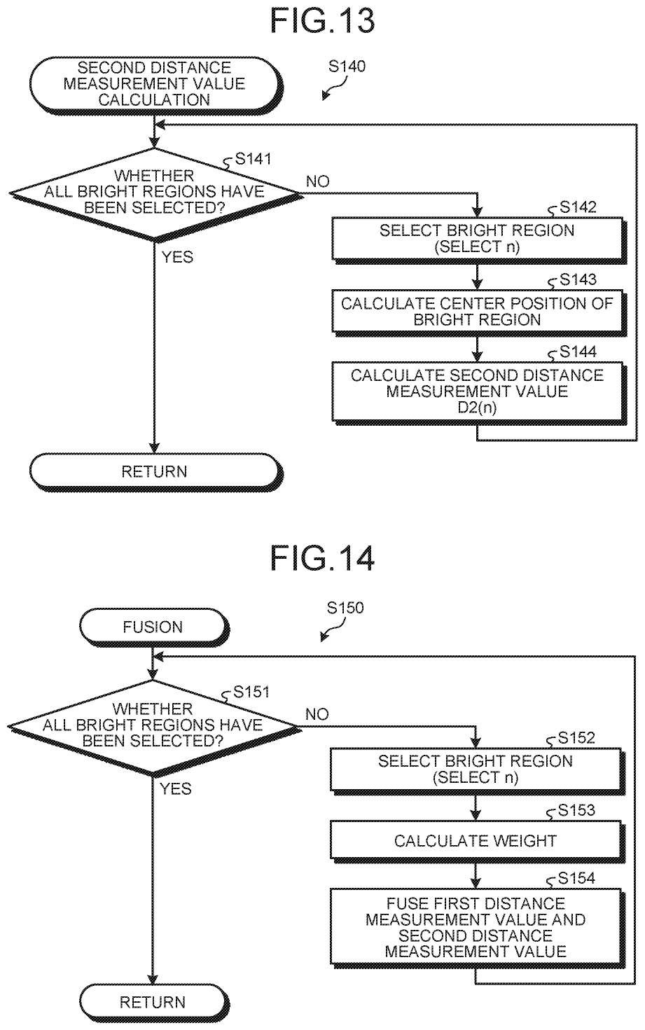

FIG. 13 is a diagram illustrating an example of second distance measurement value calculation processing according to the embodiment of the present disclosure. This diagram is a diagram illustrating an example of the second distance measurement value calculation processing (Step S140) in FIG. 11. First, the second distance measuring unit 154 determines whether or not all the bright regions have been selected (Step S141), and in a case where not all the bright regions have been selected, selects the unselected bright region (Step S142). At this time, the second distance measuring unit 154 selects the position number n of the bright region 370. Next, the second distance measuring unit 154 calculates the center position of the selected bright region (Step S143). Next, the second distance measuring unit 154 calculates the second distance measurement value by triangulation (Step S144). Next, the second distance measuring unit 154 returns to the process of Step S141. On the other hand, in the process of Step S141, in a case where all the bright regions have been selected (Step S141, Yes), the second distance measuring unit 154 completes the second distance measurement value calculation processing S140.

### [Fusion Processing]

FIG. 14 is a diagram illustrating an example of fusion processing according to the embodiment of the present disclosure. This diagram is a diagram illustrating an example of the fusion processing (Step S150) in FIG. 11. First, the fusion unit 155 determines whether or not all the bright regions have been selected (Step S151), and in a case where not all the bright regions have been selected, selects the unselected bright region (Step S152). At this time, the fusion unit 155 selects the position number n of the bright region 370. Next, the fusion unit 155 calculates a weight in the selected bright region (Step S143). Next, the fusion unit 155 fuses the first distance measurement value and the second distance measurement value using the calculated weight (Step S154). Next, the fusion unit 155 returns to the process of Step S151. On the other hand, in the process of Step S151, in a case where all the bright regions have been selected (Step S151, Yes), the fusion unit 155 completes the fusion processing S150.

As described above, the distance measuring system 1 according to the first embodiment of the present disclosure generates a fused distance measurement value by fusing the first distance measurement value calculated by the indirect ToF method and the second distance measurement value calculated by triangulation. By fusing the distance measurement value obtained by triangulation, in which distance measurement is performed in a relatively short time, to the distance measurement value obtained by the indirect ToF method, it is possible to reduce an error caused when the object 9 moves. In addition, by selecting the bright region 370 having the largest luminance difference from the dark region 360 among the bright regions 370 at the time of distance measurement by triangulation, it is possible to improve the accuracy of distance measurement by triangulation.

### 2. Second Embodiment

The distance measuring system 1 according to the first embodiment described above selects the bright region 370 having the largest luminance difference among the bright regions 370 of the four images. On the other hand, the distance measuring system 1 according to a second embodiment of the present disclosure is different from that of the above-described first embodiment in that the image having the largest luminance difference among the four images is selected as an image for measurement.

### [Bright Region Selection Processing]

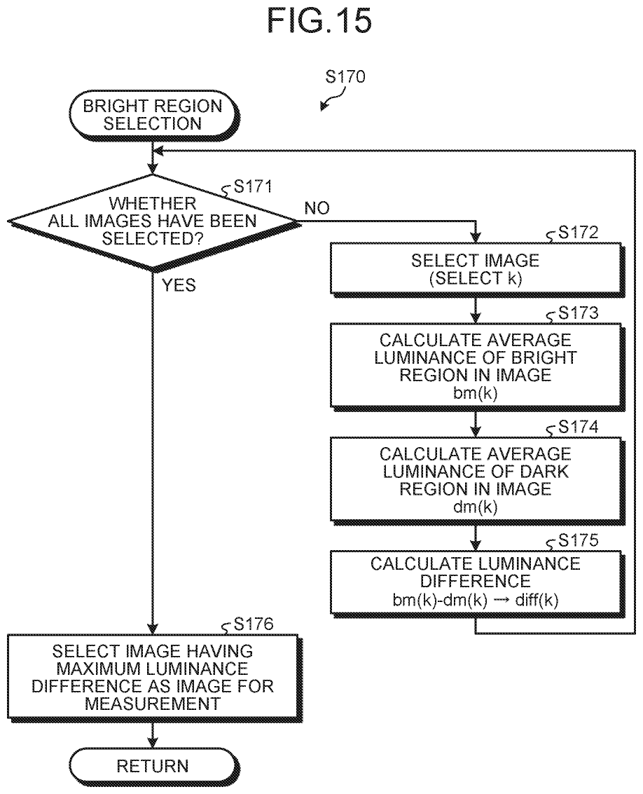

FIG. 15 is a diagram illustrating an example of bright region selection processing according to the second embodiment of the present disclosure. This diagram is a diagram illustrating an example of the bright region selection processing (Step S170) as in FIG. 11. The processing in this diagram is different from the processing in FIG. 11 in that the image having the largest luminance difference among the four images is selected as the image for measurement.

First, the bright region selecting unit 153 determines whether or not all the images have been selected (Step S171), and in a case where not all the images have been selected (Step S171, No), selects the unselected image (Step S172). At this time, the bright region selecting unit 153 selects an image number k. Next, the bright region selecting unit 153 calculates the average luminance of the bright region in the selected image (Step S173). At this time, the bright region selecting unit 153 calculates the average luminance bm (k).

Next, the bright region selecting unit 153 calculates the average luminance of the dark region in the selected image (Step S174). At this time, the bright region selecting unit 153 calculates the average luminance dm (k). Next, the bright region selecting unit 153 calculates a luminance difference (Step S175). At this time, the bright region selecting unit 153 calculates bm (k)−dm (k) and outputs its result as diff (k). Next, the bright region selecting unit 153 returns to the process of Step S171.

On the other hand, in Step S171, in a case where all the images have been selected (Step S171, Yes), the process proceeds to Step S176. In Step S176, the bright region selecting unit 153 selects the image having the maximum luminance difference as an image for measurement (Step S176). Thereafter, the bright region selecting unit 153 terminates the bright region selection processing S170.

Since the configuration of the distance measuring system 1 other than this is the same as the configuration of the distance measuring system 1 in the first embodiment of the present disclosure, the description thereof will be omitted.

As described above, the distance measuring system 1 according to the second embodiment of the present disclosure selects the image having the largest luminance difference among the images generated by the indirect ToF method as the image for measurement. As a result, the influence of the movement of the object 9 can be further reduced.

### 3. Third Embodiment

In the distance measuring system 1 according to the first embodiment described above, the first distance measurement value and the second distance measurement value are fused. On the other hand, the distance measuring system 1 according to a third embodiment of the present disclosure is different from that of the above-described first embodiment in that fusion is performed according to variation in the second distance measurement value for each pixel.

### [Fusion Processing]

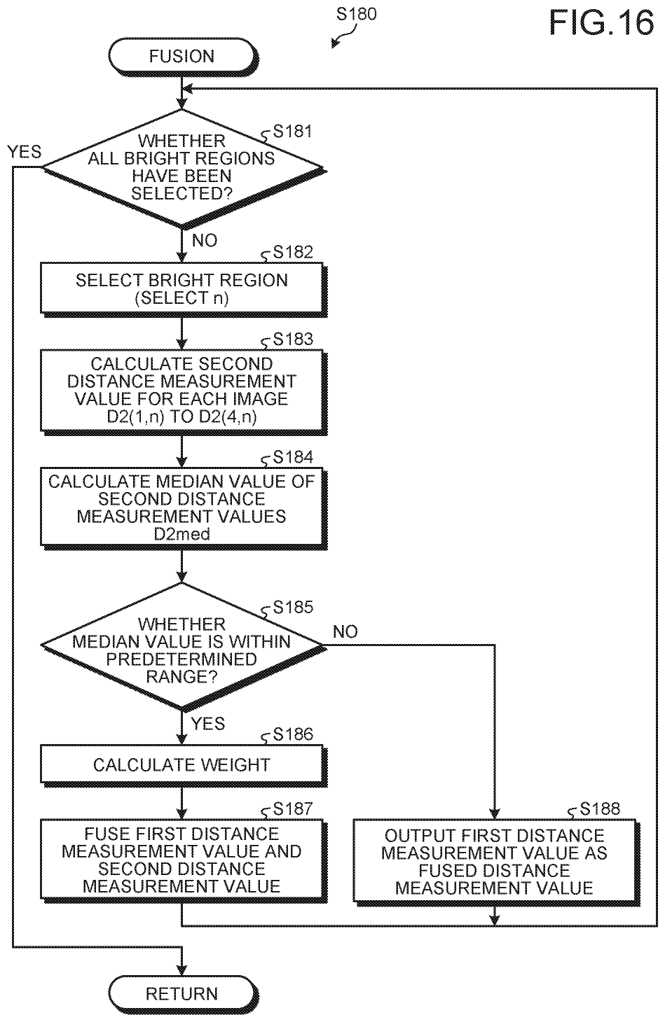

FIG. 16 is a diagram illustrating an example of fusion processing according to the third embodiment of the present disclosure. This diagram illustrates processing performed in place of the fusion processing S150 in FIG. 11. First, the fusion unit 155 determines whether or not all the bright regions have been selected (Step S181), and in a case where not all the bright regions have been selected, selects the unselected bright region (Step S182). At this time, the fusion unit 155 selects the position number n of the bright region 370. Next, the fusion unit 155 calculates the second distance measurement value for each image (Step S183). At this time, the fusion unit 155 calculates the second distance measurement values D2 (1, n) to D2 (4, n). Next, the fusion unit 155 calculates a median value of the second distance measurement values (Step S184). At this time, the fusion unit 155 calculates a median value D2med.

Next, the fusion unit 155 determines whether or not the median value is within a predetermined range (Step S185). As a result, in a case where the median value is not within the predetermined range (Step S185, No), the fusion unit 155 outputs the first distance measurement value as a fused distance measurement value (Step S188), and returns to the process of Step S181.

On the other hand, in Step S185, in a case where the median value is within the predetermined range (Step S185, Yes), the fusion unit 155 calculates a weight (Step S186) and fuses the first distance measurement value and the second distance measurement value (Step S187). Next, the fusion unit 155 returns to the process of Step S181.

In the process of Step S181, in a case where all the bright regions have been selected (Step S181, Yes), the fusion unit 155 completes the fusion processing S180.

Since the configuration of the distance measuring system 1 other than this is the same as the configuration of the distance measuring system 1 in the first embodiment of the present disclosure, the description thereof will be omitted.

As described above, the third distance measuring system 1 of the present disclosure calculates the variation in the second distance measurement value for each image, and outputs the first distance measurement value as the fused distance measurement value in a case where the variation in the second distance measurement value is not within the predetermined range. This makes it possible to reduce mixing of an error in distance measurement by triangulation and improve accuracy of distance measurement.

Note that, the effects described in this specification are merely examples and are not limited, and other effects may be provided.

Note that, the present technique can also have the following configuration.

(1)

A distance measuring device comprising:
a distance measuring sensor configured to generate a plurality of images by receiving reflected light, which is obtained by reflecting pulse train pattern light that repeats a light emission period and a non-light emission period of two types of luminance of a bright portion and a dark portion by an object, in light reception periods that are each synchronized with the light emission period and have different phases from each other;
a bright region detecting unit configured to detect a bright region which is a region generated by receiving the reflected light corresponding to the bright portion of the pattern light in each of the plurality of images;
a first distance measuring unit configured to detect a phase difference between the emitted pattern light and the reflected light on the basis of the bright regions detected in the plurality of images and calculate a first distance measurement value that is a distance to the object on the basis of the detected phase difference;
a bright region selecting unit configured to select among the bright regions, detected in the plurality of images, on the basis of image signals constituting the images;
a second distance measuring unit configured to calculate a second distance measurement value that is a distance to the object by triangulation using a position of the selected bright region in the image; and
a fusion unit configured to generate a fused distance measurement value by fusing the calculated first distance measurement value and the calculated second distance measurement value.

(2)

The distance measuring device according the above (1),
wherein the bright region selecting unit performs the selection on the basis of a difference between the image signal in each of the detected bright regions and the image signal in a region corresponding to the dark portion.

(3)

The distance measuring device according to the above (2), wherein the bright region selecting unit selects, among the bright regions detected in the plurality of images, the bright region in which the difference from the region corresponding to the dark portion in the image including the bright region is maximized.

(4)

The distance measuring device according to the above (2), wherein the bright region selecting unit selects the bright region included in the image in which the difference between the region corresponding to the dark portion and the bright region in the image is maximized.

(5)

The distance measuring device according to any one of the above (1) to (4), wherein the bright region selecting unit performs the selection on the basis of a noise component of the image signal in each of the detected bright regions.

(6)

The distance measuring device according to any one of the above (1) to (5), wherein the pattern light is constituted of a dot pattern in which a plurality of dots are arranged.

(7)

The distance measuring device according to any one of the above (1) to (6), wherein the fusion unit performs the fusion by weighted addition of the calculated first distance measurement value and the calculated second distance measurement value.

(8)

The distance measuring device according to the above (7), wherein the fusion unit performs the weighted addition on the basis of a weight corresponding to a difference between the calculated first distance measurement value and the calculated second distance measurement value.

(9)

A distance measuring system comprising:
a light source device configured to emit pulse train pattern light that repeats a light emission period and a non-light emission period of two types of luminance of a bright portion and a dark portion;
a distance measuring sensor configured to generate a plurality of images by receiving reflected light, which is obtained by reflecting the emitted pattern light by an object, in light reception periods that are each synchronized with the light emission period and have different phases from each other;
a bright region detecting unit configured to detect a bright region which is a region generated by receiving the reflected light corresponding to the bright portion of the pattern light in each of the plurality of images;
a first distance measuring unit configured to detect a phase difference between the emitted pattern light and the reflected light on the basis of the bright regions detected in the plurality of images and calculate a first distance measurement value that is a distance to the object on the basis of the detected phase difference;
a bright region selecting unit configured to select among the bright regions, detected in the plurality of images, on the basis of image signals constituting the images;
a second distance measuring unit configured to calculate a second distance measurement value that is a distance to the object by triangulation using a position of the selected bright region in the image; and
a fusion unit configured to generate a fused distance measurement value by fusing the calculated first distance measurement value and the calculated second distance measurement value.

### REFERENCE SIGNS LIST

1 DISTANCE MEASURING SYSTEM
10 DISTANCE MEASURING DEVICE
20 LIGHT SOURCE DEVICE
21 LIGHT SOURCE UNIT
22 DRIVE UNIT
100 DISTANCE MEASURING SENSOR
110 PIXEL ARRAY UNIT
151 BRIGHT REGION DETECTING UNIT
152 FIRST DISTANCE MEASURING UNIT
153 BRIGHT REGION SELECTING UNIT
154 SECOND DISTANCE MEASURING UNIT
155 FUSION UNIT
200 PIXEL
351 to 354 IMAGE
360 DARK REGION
361 PERIPHERAL REGION
370, 371 BRIGHT REGION

1. A distance measuring device comprising:
a distance measuring sensor configured to generate a plurality of images by receiving reflected light, which is obtained by reflecting pulse train pattern light that repeats a light emission period and a non-light emission period of two types of luminance of a bright portion and a dark portion by an object, in light reception periods that are each synchronized with the light emission period and have different phases from each other;
a bright region detecting unit configured to detect a bright region which is a region generated by receiving the reflected light corresponding to the bright portion of the pattern light in each of the plurality of images;
a first distance measuring unit configured to detect a phase difference between the emitted pattern light and the reflected light on the basis of the bright regions detected in the plurality of images and calculate a first distance measurement value that is a distance to the object on the basis of the detected phase difference;
a bright region selecting unit configured to select among the bright regions, detected in the plurality of images, on the basis of image signals constituting the images;
a second distance measuring unit configured to calculate a second distance measurement value that is a distance to the object by triangulation using a position of the selected bright region in the image; and
a fusion unit configured to generate a fused distance measurement value by fusing the calculated first distance measurement value and the calculated second distance measurement value.

2. The distance measuring device according to claim 1, wherein the bright region selecting unit performs the selection on the basis of a difference between the image signal in each of the detected bright regions and the image signal in a region corresponding to the dark portion.

3. The distance measuring device according to claim 2, wherein the bright region selecting unit selects, among the bright regions detected in the plurality of images, the bright region in which the difference from the region corresponding to the dark portion in the image including the bright region is maximized.

4. The distance measuring device according to claim 2, wherein the bright region selecting unit selects the bright region included in the image in which the difference between the region corresponding to the dark portion and the bright region in the image is maximized.

5. The distance measuring device according to claim 1, wherein the bright region selecting unit performs the selection on the basis of a noise component of the image signal in each of the detected bright regions.

6. The distance measuring device according to claim 1, wherein the pattern light is constituted of a dot pattern in which a plurality of dots are arranged.

7. The distance measuring device according to claim 1, wherein the fusion unit performs the fusion by weighted addition of the calculated first distance measurement value and the calculated second distance measurement value.

8. The distance measuring device according to claim 7, wherein the fusion unit performs the weighted addition on the basis of a weight corresponding to a difference between the calculated first distance measurement value and the calculated second distance measurement value.

9. A distance measuring system comprising:
a light source device configured to emit pulse train pattern light that repeats a light emission period and a non-light emission period of two types of luminance of a bright portion and a dark portion;
a distance measuring sensor configured to generate a plurality of images by receiving reflected light, which is obtained by reflecting the emitted pattern light by an object, in light reception periods that are each synchronized with the light emission period and have different phases from each other;
a bright region detecting unit configured to detect a bright region which is a region generated by receiving the reflected light corresponding to the bright portion of the pattern light in each of the plurality of images;
a first distance measuring unit configured to detect a phase difference between the emitted pattern light and the reflected light on the basis of the bright regions detected in the plurality of images and calculate a first distance measurement value that is a distance to the object on the basis of the detected phase difference;
a bright region selecting unit configured to select among the bright regions, detected in the plurality of images, on the basis of image signals constituting the images;
a second distance measuring unit configured to calculate a second distance measurement value that is a distance to the object by triangulation using a position of the selected bright region in the image; and
a fusion unit configured to generate a fused distance measurement value by fusing the calculated first distance measurement value and the calculated second distance measurement value.
